(19) United States
(12) Patent Application Publication
(10) Pub. No.: US 2026/0163288 A1
(43) Pub. Date: Jun. 11, 2026

(54) HARNESS ASSEMBLY WITH AN END NODE HARNESS CONNECTOR FOR AN ELECTRICAL CONNECTOR SYSTEM

(71) Applicant: TE Connectivity Solutions GmbH, Schaffhausen (CH)

(72) Inventor: Galen M. Martin, Middletown, PA (US)

(21) Appl. No.: 19/407,252

(22) Filed: Dec. 3, 2025

Related U.S. Application Data
(60) Provisional application No. 63/729,991, filed on Dec. 10, 2024.

(51) Int. Cl. H01R 13/432

(52) U.S. Cl. CPC H01R 13/432; H01R 2201/26

(57) ABSTRACT

A harness assembly includes a cable assembly includes a plurality of wires and a harness connector with a harness connector housing and harness connector terminals terminated to the corresponding wires of the cable assembly. The harness connector housing includes a mating end for mating with a device connector of an electrical device and a cable end with the wires extending therefrom. The harness connector housing includes terminal channels holding the corresponding harness connector terminals. Each harness connector terminal includes a mating end and a terminating end. The mating end is configured to be mated with a device terminal of the device connector to create a signal path between the wire and the corresponding device terminal. The harness assembly includes bus terminals received in the harness connector housing each having mating beams configured to be electrically connected to the corresponding harness connector terminal for electrical bussing of corresponding signal paths.

### CROSS REFERENCE TO RELATED APPLICATIONS

This application claims priority to U.S. Application No. 63/729,991, filed 10 Dec. 2024, the subject matter of which is herein incorporated by reference in its entirety.

### BACKGROUND OF THE INVENTION

The subject matter herein relates generally to harness assemblies for electrical connector systems.

Modern vehicles employ a growing number of electronic devices, sensors, and actuators that must communicate with a central controller. In many known architectures, each device is connected to the controller by a dedicated wire harness. As the number of devices increases, these point-to-point wiring schemes result in substantial wiring complexity, requiring numerous individual conductors, connectors, and routing paths throughout the vehicle. The large quantity of wire harnesses increases assembly time, packaging constraints, weight, and cost, and also introduces additional potential failure points at each electrical connection.

To reduce wiring complexity, some systems implement networked communication, such as Ethernet-based architectures, that allow multiple devices to share communication lines. Certain known systems employ bussing or daisy-chain topologies in which devices are connected in series along a common communication bus. While bussing can reduce the total number of wires needed, it introduces other drawbacks. In particular, the proper operation of downstream devices depends on each upstream device and its associated wiring and connectors being intact. A failure, disconnection, or degradation at any point in the daisy chain can interrupt communication to all devices located downstream on the bus. Furthermore, bussed architectures often require specialized connectors, termination components, and additional circuitry to maintain signal integrity, increasing system complexity and cost. As the number of devices grows, these systems become increasingly difficult to package and assemble.

Accordingly, there is a need for an improved vehicle networking architecture that reduces wiring complexity and cost while avoiding the dependency and failure propagation issues associated with daisy-chain or bussed Ethernet systems.

### BRIEF DESCRIPTION OF THE INVENTION

In an embodiment, a harness assembly is provided and includes a cable assembly includes a plurality of wires. The harness assembly includes a harness connector that includes a harness connector housing and harness connector terminals terminated to the corresponding wires of the cable assembly. The harness connector housing includes a mating end configured to be mated with a device connector of an electrical device and a cable end with the wires extending from the cable end. The harness connector housing includes terminal channels holding the corresponding harness connector terminals. Each harness connector terminal includes a mating end and a terminating end. The terminating end terminated to an end of the corresponding wire. The mating end configured to be mated with a device terminal of the device connector to create a signal path between the wire and the corresponding device terminal. The harness assembly includes bus terminals received in the harness connector housing. Each bus terminal includes mating beams configured to be electrically connected to the corresponding harness connector terminal for electrical bussing of corresponding signal paths.

In another embodiment, a harness assembly is provided and includes a cable assembly that includes a plurality of wires. The harness assembly includes a drop node harness connector that includes a drop node harness connector housing and drop node harness connector terminals terminated to the corresponding wires of the cable assembly. The drop node harness connector housing includes a mating end configured to be mated with a corresponding device connector of an electrical device and a cable end with the wires extending from the cable end. The drop node harness connector housing includes terminal channels holding the corresponding drop node harness connector terminals. Each drop node harness connector terminal includes a drop node mating end and a drop node terminating end. The drop node terminating end terminated to an end of the corresponding wire. The drop node mating end configured to be mated with a device terminal of the corresponding device connector to create a signal path between the wire and the corresponding device terminal. The drop node harness connector includes drop node bus terminals received in the drop node harness connector housing. Each drop node bus terminal includes drop node mating beams configured to be electrically connected to corresponding drop node harness connector terminals for electrical bussing between the drop node harness connector terminals. The harness assembly includes an end node harness connector that includes an end node harness connector housing and end node harness connector terminals terminated to the corresponding wires of the cable assembly. The end node harness connector housing includes a mating end configured to be mated with a corresponding device connector of an electrical device and a cable end with the wires extending from the cable end. The end node harness connector housing includes terminal channels holding the corresponding end node harness connector terminals. Each end node harness connector terminal includes an end node mating end and an end node terminating end. The end node terminating end terminated to an end of the corresponding wire. The end node mating end configured to be mated with a device terminal of the corresponding device connector to create a signal path between the wire and the corresponding device terminal. The end node harness connector includes end node bus terminals received in the end node harness connector housing. Each end node bus terminal includes end node mating beams configured to be electrically connected to corresponding end node harness connector terminals and corresponding device terminals for electrical bussing between the end node harness connector terminals and the device terminals.

In a further embodiment, an electrical connector system for a vehicle is provided. The electrical connector system includes electrical devices electrically connected to a device controller. Each electrical device includes a circuit board, a device housing mounted to the circuit board, and device terminals held by the device housing and coupled to the circuit board. The electrical connector system includes a harness assembly electrically connected to the electrical devices. The harness assembly includes a cable assembly includes a plurality of wires and harness connectors coupled to the corresponding wires of the cable assembly and configured to be mated with the corresponding electrical devices. The harness assembly includes bussing components for electrical bussing of the electrical devices. Each harness connector includes a harness connector housing and harness connector terminals terminated to the corresponding wires of the cable assembly. The harness connector housing includes a mating end configured to be mated with the corresponding device connector and a cable end with the wires extending from the cable end. The harness connector housing includes terminal channels holding the corresponding harness connector terminals. Each harness connector terminal includes a mating end and a terminating end. The terminating end terminated to an end of the corresponding wire. The mating end configured to be mated with the corresponding device terminal of the device connector to create a signal path between the wire and the corresponding device terminal. Each harness connector holding bus terminals in the harness connector housing. The bus terminals include mating beams electrically connected to the corresponding harness connector terminals for electrical bussing of the electrical devices.

### BRIEF DESCRIPTION OF THE DRAWINGS

FIG. 1 illustrates an electrical connector system in accordance with an exemplary embodiment.

FIG. 2 illustrates a portion of the electrical connector system in accordance with an exemplary embodiment.

FIG. 3 is a perspective view of a portion of the electrical connector system showing one of the harness connectors mated with one of the electrical devices in accordance with an exemplary embodiment.

FIG. 4 is a perspective view of a drop node bus terminal in accordance with an exemplary embodiment.

FIG. 5 is a front perspective view of a portion of the drop node harness connector in accordance with an exemplary embodiment.

FIG. 6 is a front perspective view of a portion of the drop node harness connector in accordance with an exemplary embodiment.

FIG. 7 is a front view of the drop node harness connector in accordance with an exemplary embodiment.

FIG. 8 is an enlarged front view of a portion of the drop node harness connector in accordance with an exemplary embodiment.

FIG. 9 is an exploded view of a portion of the drop node harness connector in accordance with an exemplary embodiment showing the harness connectors terminals and the drop node bus terminals.

FIG. 10 is an assembled view of a portion of the drop node harness connector in accordance with an exemplary embodiment showing the harness connectors terminals and the drop node bus terminals.

FIG. 11 illustrates a portion of the electrical connector system showing the device terminals mated with the harness connectors terminals and showing the drop node bus terminals providing electrical busing for the corresponding signal paths in accordance with an exemplary embodiment.

FIG. 12 is a cross sectional view of a portion of the electrical connector system showing the drop node harness connector coupled to the corresponding electrical device in accordance with an exemplary embodiment.

FIG. 13 is a perspective view of an end node bus terminal in accordance with an exemplary embodiment.

FIG. 14 is a front perspective view of a portion of the end node harness connector in accordance with an exemplary embodiment showing the end node bus terminals arranged therein as a bussing component.

FIG. 15 is a front perspective view of a portion of the end node harness connector in accordance with an exemplary embodiment.

FIG. 16 is a front perspective view of a portion of the end node harness connector in accordance with an exemplary embodiment.

FIG. 17 is a front view of the end node harness connector in accordance with an exemplary embodiment.

FIG. 18 is an enlarged front view of a portion of the end node harness connector in accordance with an exemplary embodiment.

FIG. 19 is an exploded view of a portion of the end node harness connector in accordance with an exemplary embodiment showing the harness connectors terminals and the end node bus terminals.

FIG. 20 is an assembled view of a portion of the end node harness connector in accordance with an exemplary embodiment showing the harness connectors terminals and the end node bus terminals.

FIG. 21 illustrates a portion of the electrical connector system showing the device terminals mated with the harness connectors terminals and showing the end node bus terminals providing electrical busing for the corresponding signal paths in accordance with an exemplary embodiment.

FIG. 22 is a perspective view of a portion of the electrical connector system showing the electrical device and a portion of the end node harness connector, with the harness connector housing removed to illustrate the harness connector terminals, the bussed harness connector terminals, and the end node bus terminals in accordance with an exemplary embodiment.

FIG. 23 is a cross sectional view of a portion of the electrical connector system showing the end node harness connector coupled to the corresponding electrical device in accordance with an exemplary embodiment.

### DETAILED DESCRIPTION OF THE INVENTION

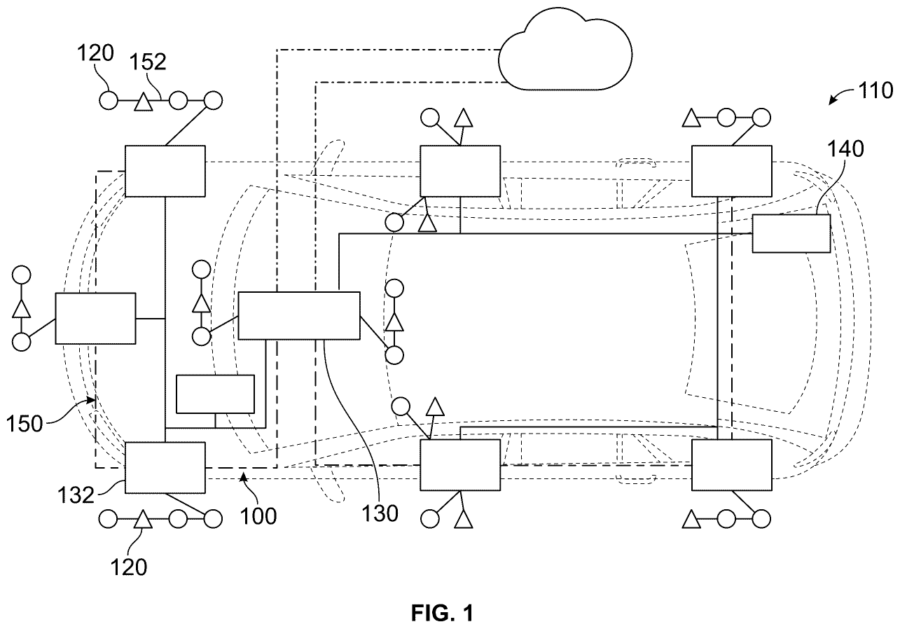

FIG. 1 illustrates an electrical connector system 100 in accordance with an exemplary embodiment. In the illustrated embodiment, the electrical connector system 100 is utilized within a vehicle 110, such as an automotive vehicle, an electric vehicle, or other type of vehicle. The electrical connector system 100 may be utilized in other applications in alternative embodiments.

The electrical connector system 100 is used to provide communication and/or power transfer between various electrical devices 120 within the vehicle 110. For example, the electrical connector system 100 may connect the electrical devices 120 with a central computer 130 and/or power source 140, such as a battery of the vehicle. The electrical connector system 100 may allow high-speed data communication between the central computer 130 and the electrical devices 120. In various embodiments, the electrical connector system 100 may provide regional or zonal communication between multiple zonal control modules 132, which are connected to the central computer 130, and which are connected to multiple electrical devices 120 within a region or zone of the vehicle 110, such as a front zone, a front right zone, a front left zone, a middle right zone, a middle left zone, a rear right zone, a rear left zone, or other zones.

The electrical devices 120 may be any type of electrical device within the vehicle 110 for controlling functions or operations of the vehicle 110. Examples of the electrical devices 120 may include lighting elements, such as lamps, headlamps, taillights, lock actuators, motors, speakers, microphones, cameras, radar devices, displays, imaging radar devices, lidar devices, antennas, communication devices, and the like. The electrical devices 120 are coupled to the central computer 130, such as via the zonal control modules 132, by one or more cable assemblies 150. The cable assemblies 150 include one or more wires 152 routed between the various components. In an exemplary embodiment, the electrical connector system 100 provides electrical bussing between the electrical devices 120 and the corresponding control module 132 to reduce the number of connections and/or the number of wires 152 within the electrical connector system 100. The electrical connector system 100 provides a daisy-chained network that reduces the number of wires and connections.

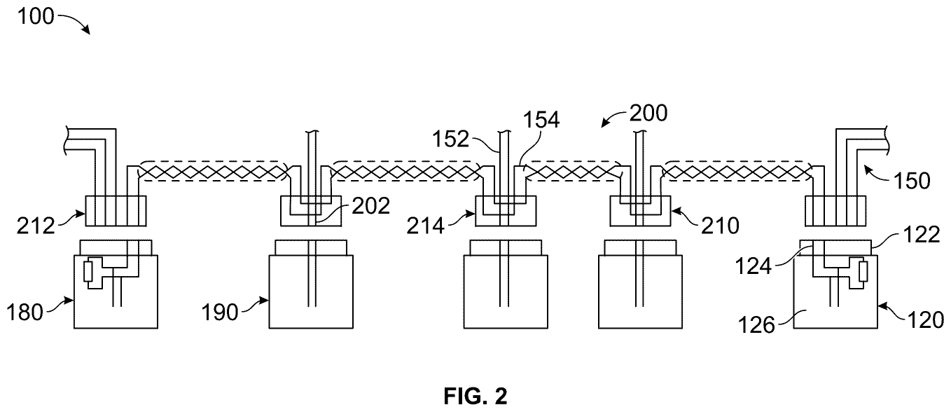

FIG. 2 illustrates a portion of the electrical connector system 100 in accordance with an exemplary embodiment. The electrical connector system 100 includes a harness assembly 200 that is connected to a plurality of the electrical devices 120. For example, the harness assembly 200 includes the cable assembly 150 and a plurality of harness connectors 210 that are connected to the corresponding electrical devices 120. The harness assembly 200 provides a daisy chained connection with the electrical devices 120. The harness assembly 200 includes bussing components 202 for electrical bussing of the electrical devices 120.

Each electrical device 120 includes a device housing 122 and device terminals 124 held by the device housing 122. In various embodiments, the electrical device 120 may be a board connector mounted to a circuit board 126 with the device terminals 124 terminated to the circuit board 126. Other components may be electrically connected to the circuit board 126 and communicate with the harness connector 210 through the device terminals 124, such as for controlling operation of the vehicle. In alternative embodiments, the electrical device 120 may be a cabled connector having cables or wires terminated to the device terminals 124.

One or more of the electrical devices 120 may be an end node device 180 within the network that can send, receive, or forward data to communicate with other parts of the network, such as at one or more of the ends of the harness assembly 200. One or more of the electrical devices 120 may be a drop node device 190 within the network, such as at intervening locations along the harness assembly 200. In an exemplary embodiment, the bussing communication between the nodes 180, 190 may occur along the cable assembly 150 between the harness connectors 210. For example, the bussing components 202 may be provided within the harness connectors 210 to alleviate the need for bussing components within the electrical devices 120, such as on the circuit board 126, to reduce cost or complexity of the system.

One or more of the harness connectors 210 may be an end node harness connectors 212 within the network that can send, receive, or forward data to communicate with other parts of the network, such as at one or more of the ends of the harness assembly 200. One or more of the harness connectors 210 may be a drop node harness connectors 214 within the network, such as at intervening locations along the harness assembly 200. In an exemplary embodiment, the bussing communication between the harness connectors 210 may occur along the cable assembly 150 between the harness connectors 210. For example, the bussing components 202 may be provided within the harness connectors 210 to alleviate the need for bussing components within the electrical devices 120, such as on the circuit board 126, to reduce cost or complexity of the system.

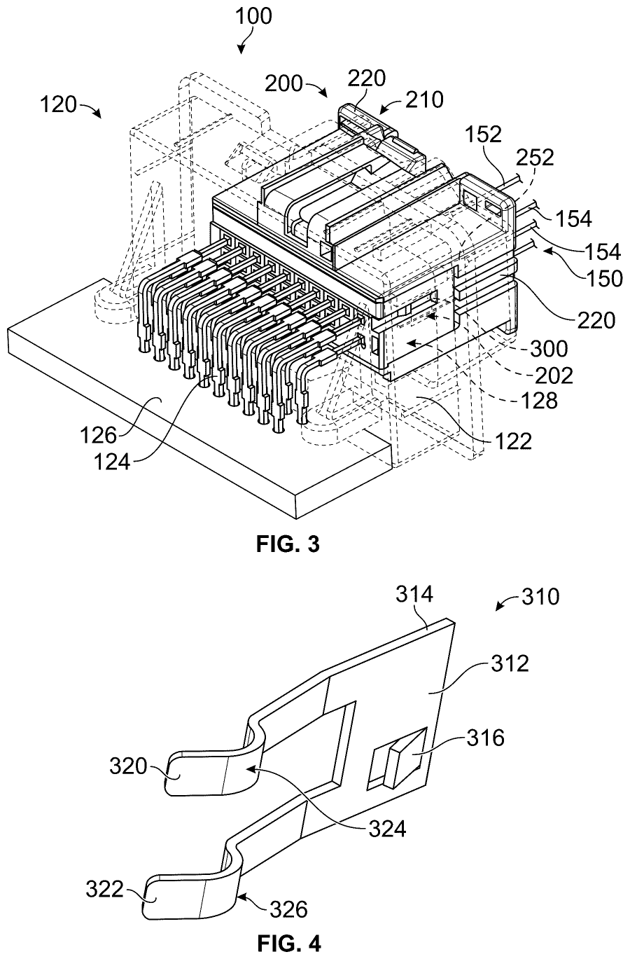

FIG. 3 is a perspective view of a portion of the electrical connector system 100 showing one of the harness connectors 210 mated with one of the electrical devices 120. In the illustrated embodiment, the device housing 122 holds the device terminals 124. The device housing 122 is mounted to the circuit board 126. The device terminals 124 are terminated to the circuit board 126. In the illustrated embodiment, the electrical device 120 is a receptacle connector having a receptacle 128 that receives a plug end of the harness connector 210. The harness connectors 210 is plugged into the receptacle 128 to mate with the device terminals 124.

The harness assembly 200 includes the cable assembly 150 and the harness assembly 210. The wires 152 of the cable assembly 150 are terminated to harness connector terminals 250 (shown in phantom). The harness connector terminals 250 are held by a harness connector housing 220. The harness connector housing 220 is plugged into the receptacle 128 of the electrical device 120 to mate the harness connector terminals 250 with the corresponding device terminals 124.

In an exemplary embodiment, the harness assembly 200 includes the bussing components 202 for electrical bussing of the signal paths through the harness assembly 200. In an exemplary embodiment, the bussing components 202 include bus terminals 300 held by the harness connector housing 220. The bus terminals 300 are configured to be electrically connected to the corresponding harness connector terminals 250. The harness connector terminals 250 that are coupled to the bus terminals 300 define bussed harness connector terminals 252. In an exemplary embodiment, the bussing components 202 include bus wires 154 of the wires 152 that are terminated to the bussed harness connector terminals 252 that are coupled to the bus terminals 300. The bus wires 154 extend between the bussed harness connector terminals 252 and bussed harness connector terminals of a different harness connector 210. The end node harness connector 212 and the drop node harness connector 214 may include similar components and features and like components are identified herein using like reference numerals. However, the end node harness connector 212 and the drop node harness connector 214 may include some different features. For example, the bus terminals 300 may be sized/shaped/positioned differently and/or may interface with different components to control the electrical bussing through the electrical connector system. For example, the end node bus terminal 300 may provide an interface directly between the bussed harness connector terminal 252 and a different device terminal 124, whereas the drop node bus terminal 300 may provide an interface directly between two different bussed harness connector terminals 252 to electrically bus the corresponding device terminals 124.

FIG. 4 is a perspective view of a drop node bus terminal 310 in accordance with an exemplary embodiment. The drop node bus terminal 310 is configured for use with the drop node harness connector 214 (shown in FIG. 2). The drop node bus terminal 310 is configured to interface directly between two different bussed harness connector terminals 252 for electrical bussing of the corresponding signal paths.

In an exemplary embodiment, the drop node bus terminal 310 is a stamped and formed part. The drop node bus terminal 310 may be stamped from a metal sheet and formed into a predetermined shape. The drop node bus terminal 310 includes a main body 312 having a base plate 314. The base plate 314 includes a retention latch 316 extending therefrom used to retain the drop node bus terminal 310 in the harness connector housing 220 (shown in FIG. 3). In an exemplary embodiment, the drop node bus terminal 310 includes a first drop node mating beam 320 and a second drop node mating beam 322. The drop node mating beams 320, 322 include corresponding mating interfaces 324, 326. The mating interfaces 324, 326 are configured to interface directly with corresponding bussed harness connector terminals 252. In the illustrated embodiment, the drop node mating beams 320, 322 are curved at distal ends thereof to form curved mating interfaces 324, 326. The drop node mating beams 320, 322 are deflectable spring beams that are independently movable to interface with the bussed harness connector terminals 252 when plugged into the harness connector housing 220. In various embodiments, the base plate 314 is oriented vertically and the drop node mating beams 320, 322 are stacked vertically, such as defining the upper and lower mating beams. The drop node bus terminal 310 may have other shapes in alternative embodiments.

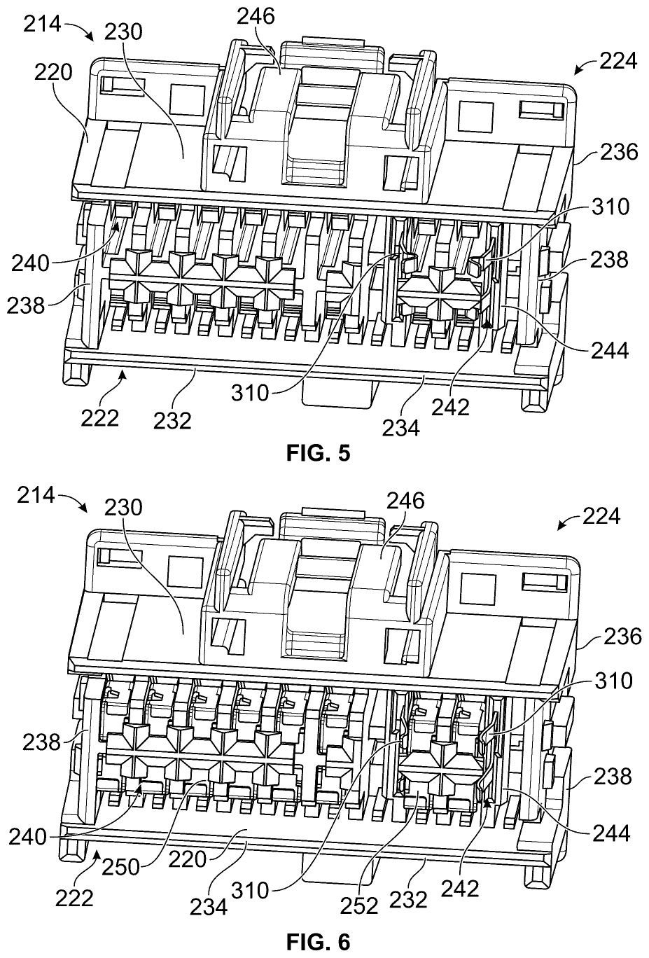

FIG. 5 is a front perspective view of a portion of the drop node harness connector 214 in accordance with an exemplary embodiment. FIG. 6 is a front perspective view of a portion of the drop node harness connector 214 in accordance with an exemplary embodiment. FIGS. 5 and 6 show the drop node bus terminals 310 in the harness connector housing 220. FIG. 6 shows the harness connector terminals 250, including the bussed harness connector terminals 252, received in the harness connector housing 220. However, the harness connector terminals 250 are removed in FIG. 5 to illustrate the drop node bus terminals 310 and portions of the harness connector housing 220.

The harness connector housing 220 includes a mating end 222 and a cable end 224. The mating end 222 is configured for mating with the corresponding electrical device 120 (FIG. 3). For example, the mating end 222 may be plugged into the receptacle 128 of the electrical device 120. The wires 152 of the cable assembly 150 are configured to extend from the cable end 224.

In an exemplary embodiment, the harness connector housing 220 is manufactured from a dielectric material, such as a plastic material. In various embodiments, the harness connector housing 220 may be a molded part. The harness connector housing 220 may have a generally rectangular shaped. However, the harness connector housing 220 may have other shapes in alternative embodiments. In an exemplary embodiment, the harness connector housing 220 includes a top 230, a bottom 232, a front 234, a rear 236, and opposite sides 238 extending between the top 230 and the bottom 232.

The harness connector housing 220 includes a plurality of terminal channels 240 that receive the corresponding harness connector terminals 250. The terminal channels 240 are open at the front 234 and the rear 236. The wires 152 extending from the harness connector terminals 250 may extend from the terminal channels 240 at the rear 236. In various embodiments, the harness connectors terminals 250 may be rear loaded into the terminal channels 240 through the rear 236. In the illustrated embodiment, the terminal channels 240 are arranged in multiple rows, such as an upper row and a lower row. The harness connector housing 220 may include greater or fewer rows in alternative embodiments. Some of the terminal channels 240 may remain open and do not receive any harness connector terminal therein. The harness connector housing 220 may be populated with the harness connector terminals 250 depending on the particular application and the number of electrical connections needed for the particular electrical device 120. In various embodiments, the harness connector 210 may include a terminal position assurance device coupled to the harness connector housing 220 configured to assure position assurance of the harness connector terminals 250 in the harness connector housing 220 after assembly.

In an exemplary embodiment, the harness connector housing 220 includes bus terminal pockets 242 that receive the corresponding drop node bus terminals 310. The bus terminal pockets 242 may be located in walls 244 that separate the terminal channels 240 from each other. The drop node bus terminals 310 may be positioned between corresponding terminal channels 240, such as to interface with the corresponding bussed harness connector terminals 252. The bus terminal pockets 242 may be open at the front 234 and/or the rear 236. In various embodiments, the drop node bus terminals 310 are configured to be front loaded into the bus terminal pockets 242. In alternative embodiments, the drop node bus terminals 310 may be rear loaded into the bus terminal pockets 242.

In an exemplary embodiment, the harness connector 210 includes a latch 246 at the exterior of the harness connector housing 220 configured to be latchably coupled to the corresponding electrical device 120. In the illustrated embodiment, the latch 246 is provided at the top 230. Other locations are possible in alternative embodiments. The latch 246 may be a deflectable latch configured to be released to allow mating of the harness connector 210 from the electrical device 120. Other types of securing features may be used in alternative embodiments.

The harness connector housing 220 may include one or more keying features for keyed mating with the electrical device 120. In harness connector housing 220 may include one or more guide features, such as guide posts, guide walls, the guide channels, and the like to guide mating with the electrical device 120.

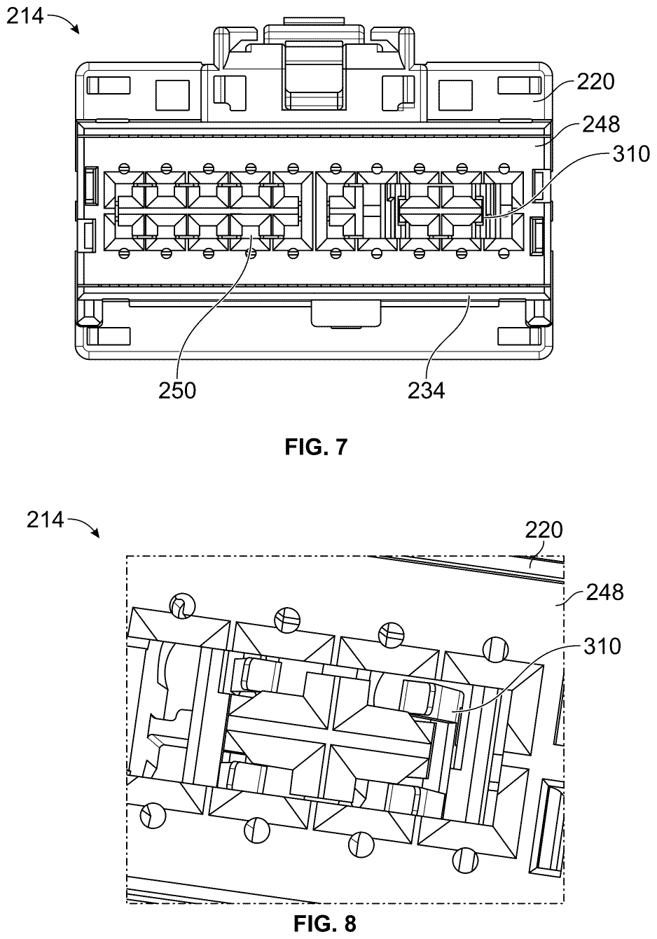

FIG. 7 is a front view of the drop node harness connector 214 in accordance with an exemplary embodiment. FIG. 8 is an enlarged front view of a portion of the drop node harness connector 214 in accordance with an exemplary embodiment. FIGS. 7 and 8 illustrate a terminal position assurance device 248 at the front 234 of the harness connector housing 220. The terminal position assurance device 248 is configured to interface with the harness connectors terminals 250 to assure proper positioning of the harness connectors terminals 250 in the harness connector housing 220 after assembly. The terminal position assurance device 248 includes an opening at the front that allows access to the harness connectors terminals 250 for mating with the device terminals 124 (shown in FIG. 3) during mating.

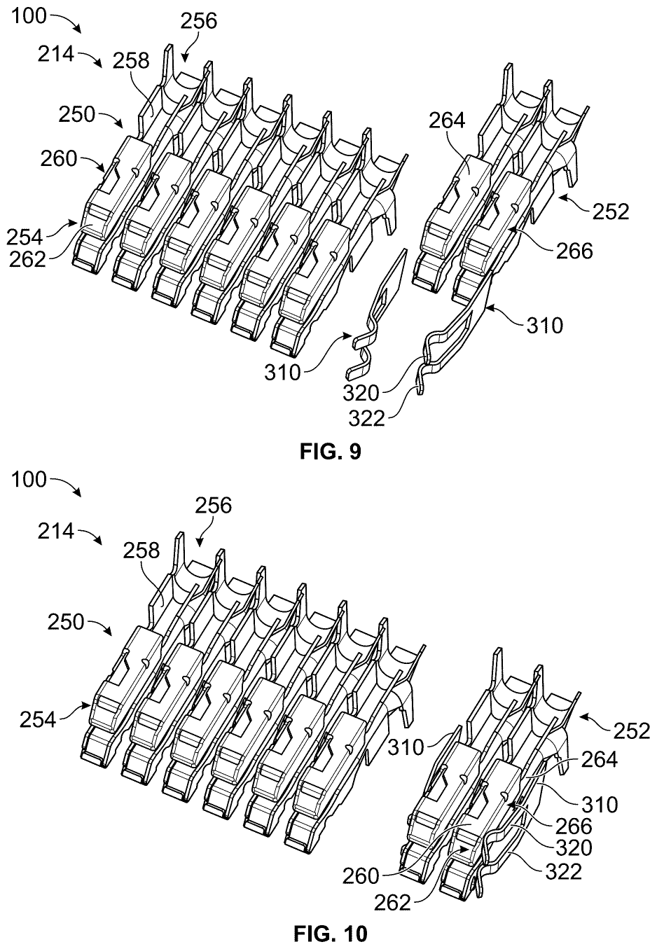

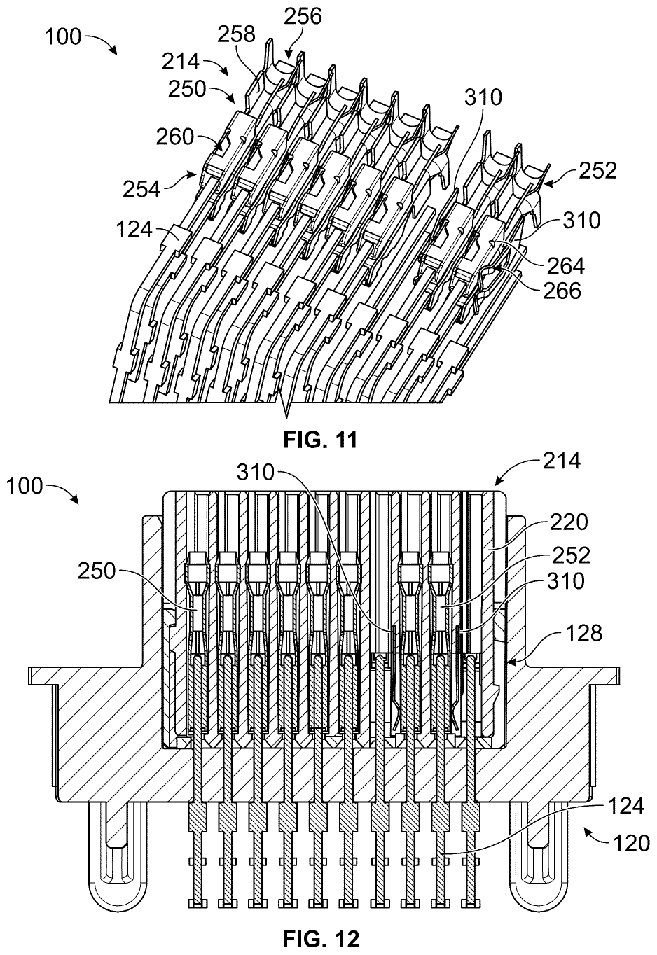

FIG. 9 is an exploded view of a portion of the drop node harness connector 214 in accordance with an exemplary embodiment showing the harness connectors terminals 250 and the drop node bus terminals 310. FIG. 10 is an assembled view of a portion of the drop node harness connector 214 in accordance with an exemplary embodiment showing the harness connectors terminals 250 and the drop node bus terminals 310. FIG. 11 illustrates a portion of the electrical connector system 100 showing the device terminals 124 mated with the harness connectors terminals 250 and showing the drop node bus terminals 310 providing electrical busing for the corresponding signal paths.

In an exemplary embodiment, the harness connector terminals 250 are stamped and formed terminals. The harness connector terminals 250 may be stamped from a metal sheet and formed into a predetermined shape. Each harness connector terminal 250 includes a mating end 254 and a terminating end 256. The mating end 254 is configured to be mated with the corresponding device terminal 124. The terminating end 256 is configured to be terminated to the corresponding signal wire 152. In the illustrated embodiment, the harness connector terminal 250 includes a crimp barrel 258 at the terminating end 256. The crimp barrel 258 is configured to be crimped to the end of the signal wire 152. Other types of terminations may be provided at the terminating end 256 in alternative embodiments, such as a weld pad or solder pad or an insulation displacement contact.

In the illustrated embodiment, the harness connector terminal 250 includes a socket 260 at the mating end 254 configured to receive the pin of the device terminal 124. Other types of mating interfaces may be provided in alternative embodiments, such as a pin, a blade, a spring beam, and the like. In the illustrated embodiment, the socket 260 is rectangular having walls along the top, the bottom, and the opposite sides of the socket 260. One or more of the walls includes a mating beam 262 extending into the socket 260 configured to interface with the device terminal 124. The harness connector terminal 250 may include a latching feature used to secure the harness connector terminal 250 and the terminal channel 240 of the harness connector housing 220. The latching feature may be a deflectable latch or a latch seat configured to interface with a latch of the harness connector housing 220. Other types of securing features may be used in alternative embodiments.

In an exemplary embodiment, the bussed harness connector terminals 252 include outer walls 264 forming mating interfaces 266. The drop node bus terminals 310 are configured to be coupled to the bussed harness connector terminals 252 at the mating interfaces 266. For example, the drop node mating beams 320, 322 may engage the mating interfaces 266 of the corresponding bussed harness connector terminals 252. As such, the drop node bus terminal 310 is configured to electrically connect a pair of the bussed harness connector terminals 252 to create a bussed signal path through the harness connectors 210. In the illustrated embodiment, the bussed harness connector terminals 252 are stacked vertically with each other. Each drop node bus terminal 310 is configured to interface with the pair of the vertically aligned bussed harness connector terminals 252, such as at the outer walls 264 thereof. In an exemplary embodiment, a pair of the bussed harness connector terminals 252 form a positive signal path and another pair of the bussed harness connector terminals 252 form a negative signal path for electrical busing through the harness connector 210.

In the illustrated embodiment, the bussed harness connector terminals 252 are provided at the first side of the drop node harness connector 214. Other locations are possible in alternative embodiments. In the illustrated embodiment, the drop node harness connector 214 includes open areas, devoid of the harness connector terminals 250 around the pairs of the bussed harness connector terminals 252 to provide space for the drop node bus terminals 310 and to isolate the bussed connections from the other signal paths through the drop node harness connector 214. However, in alternative embodiments, the drop node harness connector 214 may not include any of the areas, rather populating all of the areas with the harness connector terminals 252 provide a greater number of signal paths through the drop node harness connector 214.

FIG. 12 is a cross sectional view of a portion of the electrical connector system 100 showing the drop node harness connector 214 coupled to the corresponding electrical device 120. The harness connector housing 220 is plugged into the receptacle 128 of the electrical device 120 to mate the harness connector terminals 250 with the corresponding device terminals 124. The drop node bus terminals 310 interface directly between the bussed harness connector terminals 252 for electrical bussing of the corresponding signal paths.

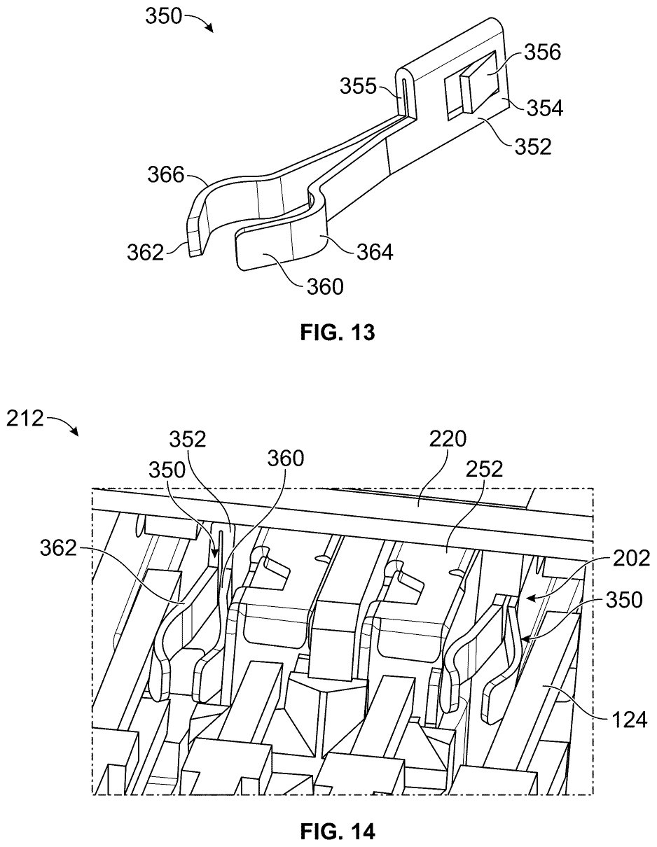

FIG. 13 is a perspective view of an end node bus terminal 350 in accordance with an exemplary embodiment. FIG. 14 is a front perspective view of a portion of the end node harness connector 212 in accordance with an exemplary embodiment showing the end node bus terminals 350 arranged therein as a bussing component 202. The end node bus terminal 350 is configured to interface directly between one of the bussed harness connector terminal 252 and the corresponding device terminal 124 and a different one of the device terminal 124. For example, the end node bus terminal 350 is configured to interface directly with an adjacent device terminal 124 to create a bussed electrical path through the assembly.

In an exemplary embodiment, the end node bus terminal 350 is a stamped and formed part. The end node bus terminal 350 may be stamped from a metal sheet and formed into a predetermined shape. The end node bus terminal 350 includes a main body 352. In the illustrated embodiment, the main body 352 is folded, such as in half, to form a first base plate 354 and a second base plate 355. In various embodiments, the end node bus terminal 350 may be identical to the drop node bus terminal 310 (FIG. 4) when stamped, but formed differently by folding the main body 352 in half to orient the mating beams differently. The first base plate 354 includes a retention latch 356 extending therefrom used to retain the end node bus terminal 350 in the harness connector housing 220 (FIG. 14).

In an exemplary embodiment, the end node bus terminal 350 includes a first end node mating beam 360 and a second end node mating beam 362. The end node mating beams 360, 362 include corresponding mating interfaces 364, 366. The first mating interface 364 is configured to interface directly with corresponding bussed harness connector terminals 252, whereas the second mating interface 366 is configured to interface directly with the adjacent device terminal 124. In the illustrated embodiment, the end node mating beams 360, 362 are curved at distal ends thereof to form curved mating interfaces 364, 366. The end node mating beams 360, 362 are deflectable spring beams that are independently movable when plugged into the harness connector housing 220. In various embodiments, the end node mating beams 360, 362 are horizontally aligned, such as at right and left sides of the end node bus terminal 350 for mating with the components when plugged into the harness connector housing 220. The end node bus terminal 350 may have other shapes in alternative embodiments.

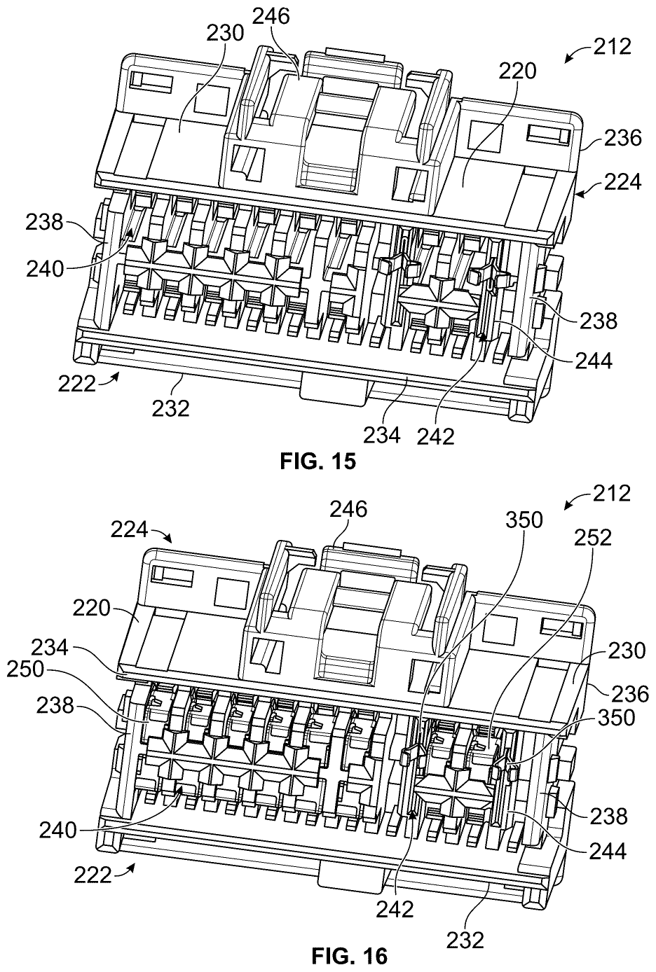

FIG. 15 is a front perspective view of a portion of the end node harness connector 212 in accordance with an exemplary embodiment. FIG. 16 is a front perspective view of a portion of the end node harness connector 212 in accordance with an exemplary embodiment. FIGS. 15 and 16 show the end node bus terminals 350 in the harness connector housing 220. FIG. 16 shows the harness connector terminals 250, including the bussed harness connector terminals 252, received in the harness connector housing 220. However, the harness connector terminals 250 are removed in FIG. 15 to illustrate the end node bus terminals 350 and portions of the harness connector housing 220.

The harness connector housing 220 includes the mating end 222 and the cable end 224. The mating end 222 is configured for mating with the corresponding electrical device 120 (FIG. 3). For example, the mating end 222 may be plugged into the receptacle 128 of the electrical device 120. The wires 152 of the cable assembly 150 are configured to extend from the cable end 224.

In an exemplary embodiment, the harness connector housing 220 is manufactured from a dielectric material, such as a plastic material. In various embodiments, the harness connector housing 220 may be a molded part. The harness connector housing 220 may have a generally rectangular shaped. However, the harness connector housing 220 may have other shapes in alternative embodiments. In an exemplary embodiment, the harness connector housing 220 includes the top 230, the bottom 232, the front 234, the rear 236, and opposite sides 238 extending between the top 230 and the bottom 232.

The harness connector housing 220 includes a plurality of the terminal channels 240 that receive the corresponding harness connector terminals 250. The terminal channels 240 are open at the front 234 and the rear 236. The wires 152 extending from the harness connector terminals 250 may extend from the terminal channels 240 at the rear 236. In various embodiments, the harness connectors terminals 250 may be rear loaded into the terminal channels 240 through the rear 236. In the illustrated embodiment, the terminal channels 240 are arranged in multiple rows, such as an upper row and a lower row. The harness connector housing 220 may include greater or fewer rows in alternative embodiments. Some of the terminal channels 240 may remain open and do not receive any harness connector terminal therein. The harness connector housing 220 may be populated with the harness connector terminals 250 depending on the particular application and the number of electrical connections needed for the particular electrical device 120. In various embodiments, the harness connector 210 may include a terminal position assurance device coupled to the harness connector housing 220 configured to assure position assurance of the harness connector terminals 250 in the harness connector housing 220 after assembly.

In an exemplary embodiment, the harness connector housing 220 includes the bus terminal pockets 242 that receive the corresponding end node bus terminals 350. The bus terminal pockets 242 may be located in the walls 244 that separate the terminal channels 240 from each other. The end node bus terminals 350 may be positioned between corresponding terminal channels 240, such as to interface with the corresponding bussed harness connector terminals 252 and device terminals 124. The bus terminal pockets 242 may be open at the front 234 and/or the rear 236. In various embodiments, the end node bus terminals 350 are configured to be front loaded into the bus terminal pockets 242. In alternative embodiments, the end node bus terminals 350 may be rear loaded into the bus terminal pockets 242.

In an exemplary embodiment, the harness connector 210 includes the latch 246 at the exterior of the harness connector housing 220 configured to be latchably coupled to the corresponding electrical device 120. In the illustrated embodiment, the latch 246 is provided at the top 230. Other locations are possible in alternative embodiments. The latch 246 may be a deflectable latch configured to be released to allow mating of the harness connector 210 from the electrical device 120. Other types of securing features may be used in alternative embodiments.

The harness connector housing 220 may include one or more keying features for keyed mating with the electrical device 120. In harness connector housing 220 may include one or more guide features, such as guide posts, guide walls, the guide channels, and the like to guide mating with the electrical device 120.

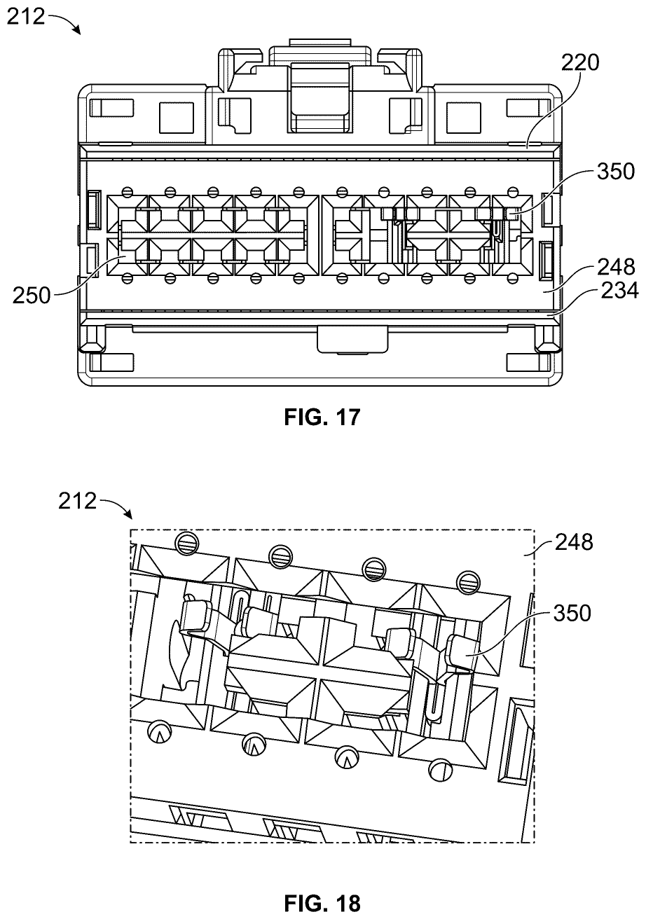

FIG. 17 is a front view of the end node harness connector 212 in accordance with an exemplary embodiment. FIG. 18 is an enlarged front view of a portion of the end node harness connector 212 in accordance with an exemplary embodiment. FIGS. 17 and 18 illustrate the terminal position assurance device 248 at the front 234 of the harness connector housing 220. The terminal position assurance device 248 is configured to interface with the harness connectors terminals 250 to assure proper positioning of the harness connectors terminals 250 in the harness connector housing 220 after assembly. The terminal position assurance device 248 includes an opening at the front that allows access to the harness connectors terminals 250 and the end node bus terminals 350 for mating with the device terminals 124 (shown in FIG. 3) during mating.

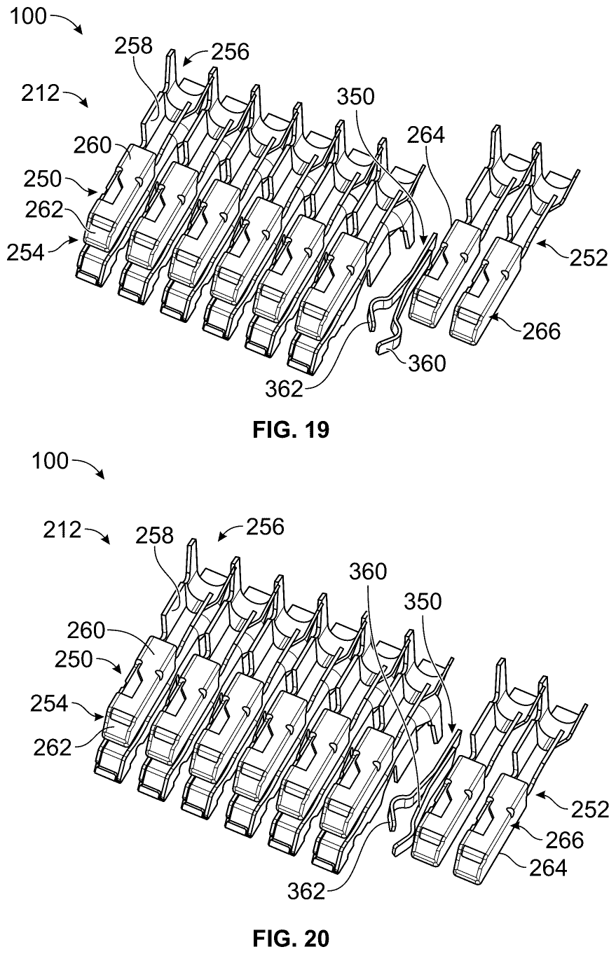

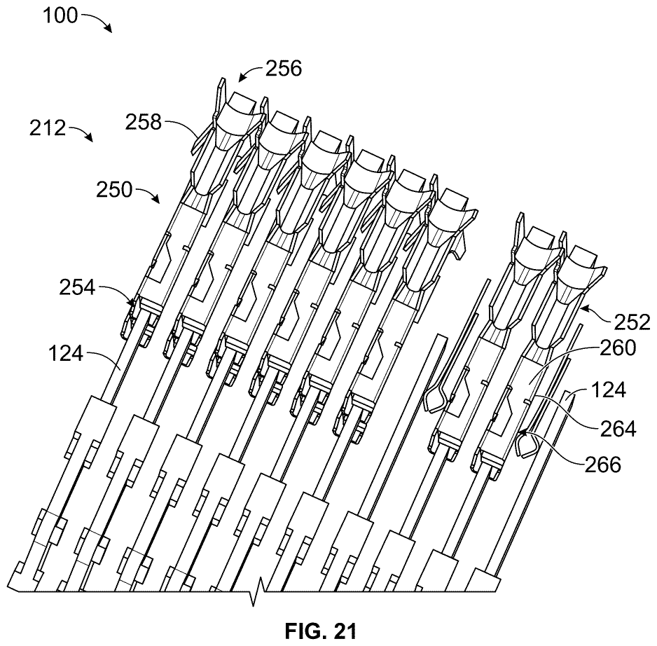

FIG. 19 is an exploded view of a portion of the end node harness connector 212 in accordance with an exemplary embodiment showing the harness connectors terminals 250 and the end node bus terminals 350. FIG. 20 is an assembled view of a portion of the end node harness connector 212 in accordance with an exemplary embodiment showing the harness connectors terminals 250 and the end node bus terminals 350. FIG. 21 illustrates a portion of the electrical connector system 100 showing the device terminals 124 mated with the harness connectors terminals 250 and showing the end node bus terminals 350 providing electrical busing for the corresponding signal paths.

In an exemplary embodiment, the harness connector terminals 250 are stamped and formed terminals. The harness connector terminals 250 may be stamped from a metal sheet and formed into a predetermined shape. Each harness connector terminal 250 includes the mating end 254 and the terminating end 256. The mating end 254 is configured to be mated with the corresponding device terminal 124. The terminating end 256 is configured to be terminated to the corresponding signal wire 152. In the illustrated embodiment, the harness connector terminal 250 includes the crimp barrel 258 at the terminating end 256. The crimp barrel 258 is configured to be crimped to the end of the signal wire 152. Other types of terminations may be provided at the terminating end 256 in alternative embodiments, such as a weld pad or solder pad or an insulation displacement contact.

In the illustrated embodiment, the harness connector terminal 250 includes the socket 260 at the mating end 254 configured to receive the pin of the device terminal 124. Other types of mating interfaces may be provided in alternative embodiments, such as a pin, a blade, a spring beam, and the like. In the illustrated embodiment, the socket 260 is rectangular having walls along the top, the bottom, and the opposite sides of the socket 260. One or more of the walls includes the mating beam 262 extending into the socket 260 configured to interface with the device terminal 124. The harness connector terminal 250 may include a latching feature used to secure the harness connector terminal 250 and the terminal channel 240 of the harness connector housing 220. The latching feature may be a deflectable latch or a latch seat configured to interface with a latch of the harness connector housing 220. Other types of securing features may be used in alternative embodiments.

In an exemplary embodiment, the bussed harness connector terminals 252 include the outer walls 264 forming the mating interfaces 266. The end node bus terminals 350 are configured to be coupled to the bussed harness connector terminals 252, and thus the associated device terminals 124, at the mating interfaces 266. For example, the first end node mating beams 360 may engage the mating interfaces 266 of the corresponding bussed harness connector terminals 252. The end node bus terminals 350 are configured to be coupled to the adjacent device terminals 124. For example, the second end node mating beams 362 may engage the adjacent device terminals 124. As such, the end node bus terminals 350 are configured to electrically connect a pair of the device terminals 124 through the connection with the bussed harness connector terminal 252 and the direct connection with the adjacent device terminal 124 to create a bussed signal path through the harness connectors 210. In the illustrated embodiment, the end node harness connector 212 only requires a pair of the bussed harness connector terminals 252 arranged side by side, rather than the vertically stacked arrangement of the drop node harness connector 212, which reduces the number of components and connections. Each end node bus terminal 350 is configured to interface with the single bussed harness connector terminals 252 and the single device terminal 124. The pair of the end node bus terminals 350 are provided to form a positive signal path and a negative signal path for electrical busing through the harness connector 210.

In the illustrated embodiment, the bussed harness connector terminals 252 are provided at the first side of the end node harness connector 212. Other locations are possible in alternative embodiments. In the illustrated embodiment, the end node harness connector 212 includes open areas, devoid of the harness connector terminals 250 around the pairs of the bussed harness connector terminals 252 to provide access to the adjacent device terminals 124 and allow electrical connection of the end node bus terminals 350 to the adjacent device terminals 124.

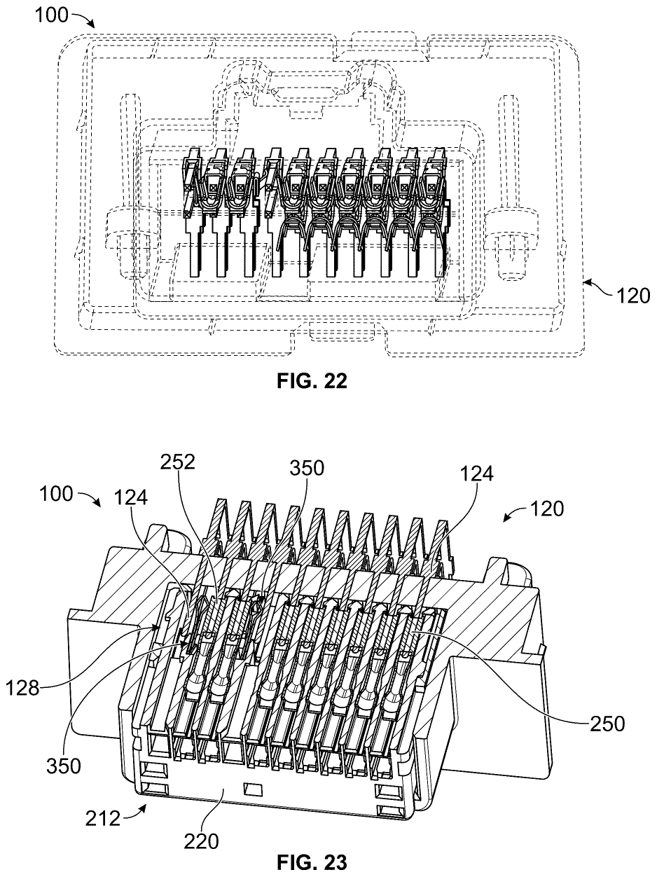

FIG. 22 is a perspective view of a portion of the electrical connector system 100 showing the electrical device and a portion of the end node harness connector 212, with the harness connector housing 220 removed to illustrate the harness connector terminals 250, the bussed harness connector terminals 252, and the end node bus terminals 350. FIG. 23 is a cross sectional view of a portion of the electrical connector system 100 showing the end node harness connector 212 coupled to the corresponding electrical device 120. The harness connector housing 220 is plugged into the receptacle 128 of the electrical device 120 to mate the harness connector terminals 250 with the corresponding device terminals 124. The end node bus terminals 350 interface directly with corresponding bussed harness connector terminals 252 and the adjacent device terminals 124 for electrical bussing of the corresponding signal paths through the system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. A harness assembly comprising:
a cable assembly including a plurality of wires;
a harness connector including a harness connector housing and harness connector terminals terminated to the corresponding wires of the cable assembly, the harness connector housing including a mating end configured to be mated with a device connector of an electrical device and a cable end with the wires extending from the cable end, the harness connector housing including terminal channels holding the corresponding harness connector terminals, each harness connector terminal including a mating end and a terminating end, the terminating end terminated to an end of the corresponding wire, the mating end configured to be mated with a device terminal of the device connector to create a signal path between the wire and the corresponding device terminal; and
bus terminals received in the harness connector housing, each bus terminal including mating beams configured to be electrically connected to the corresponding harness connector terminal for electrical bussing of corresponding signal paths.

2. The harness assembly of claim 1, wherein the bus terminals provide electrical bussing with other device connectors.

3. The harness assembly of claim 1, wherein the bus terminals make a bus connection within the harness connector by direct connection to the corresponding harness connector terminals.

4. The harness assembly of claim 1, wherein the bus terminals electrically bus the harness connector terminals to adjacent device terminals of the device connector.

5. The harness assembly of claim 1, wherein the bus terminals electrically bus together adjacent harness connector terminals.

6. The harness assembly of claim 1, wherein the mating beams of each bus terminal including a first mating beam and a second mating beam, the first mating beam having a first mating interface electrically coupled to the corresponding harness connector terminal.

7. The harness assembly of claim 6, wherein the second mating beam includes a second mating interface electrically coupled to a different harness connector terminal.

8. The harness assembly of claim 7, wherein a first mating beam is coupled to a first harness connector terminal of the harness connector terminals and the second mating beam is coupled to a second harness connector terminal of the harness connector terminals, the bus terminal electrically connecting the first and second harness connecting terminals, the first and second harness connector terminals being vertically aligned within the harness connector housing in different rows of the harness connector terminals.

9. The harness assembly of claim 6, wherein the second mating beam has a second mating interface configured to be coupled to a device terminal of the device connector.

10. The harness assembly of claim 9, wherein the first and second mating beams are deflectable toward each other.

11. The harness assembly of claim 1, wherein the mating beams of the bus terminals are configured to be electrically connected to different device terminals.

12. The harness assembly of claim 1, wherein the header connector housing includes bus terminal pockets between corresponding terminal channels, the bus terminal pockets receiving the corresponding bus terminals.

13. The harness assembly of claim 1, wherein the wires include bus wires terminated to the harness connectors terminals electrically connected to the bus terminals, the bus wires configured to be electrically connected to a different harness connector.

14. A harness assembly comprising:
a cable assembly including a plurality of wires;
a drop node harness connector including a drop node harness connector housing and drop node harness connector terminals terminated to the corresponding wires of the cable assembly, the drop node harness connector housing including a mating end configured to be mated with a corresponding device connector of an electrical device and a cable end with the wires extending from the cable end, the drop node harness connector housing including terminal channels holding the corresponding drop node harness connector terminals, each drop node harness connector terminal including a drop node mating end and a drop node terminating end, the drop node terminating end terminated to an end of the corresponding wire, the drop node mating end configured to be mated with a device terminal of the corresponding device connector to create a signal path between the wire and the corresponding device terminal, the drop node harness connector including drop node bus terminals received in the drop node harness connector housing, each drop node bus terminal including drop node mating beams configured to be electrically connected to corresponding drop node harness connector terminals for electrical bussing between the drop node harness connector terminals; and
an end node harness connector including an end node harness connector housing and end node harness connector terminals terminated to the corresponding wires of the cable assembly, the end node harness connector housing including a mating end configured to be mated with a corresponding device connector of an electrical device and a cable end with the wires extending from the cable end, the end node harness connector housing including terminal channels holding the corresponding end node harness connector terminals, each end node harness connector terminal including an end node mating end and an end node terminating end, the end node terminating end terminated to an end of the corresponding wire, the end node mating end configured to be mated with a device terminal of the corresponding device connector to create a signal path between the wire and the corresponding device terminal, the end node harness connector including end node bus terminals received in the end node harness connector housing, each end node bus terminal including end node mating beams configured to be electrically connected to corresponding end node harness connector terminals and corresponding device terminals for electrical bussing between the end node harness connector terminals and the device terminals.

15. The harness assembly of claim 14, wherein the drop node bus terminals and the end node bus terminals provide electrical bussing between different device connectors.

16. The harness assembly of claim 14, wherein each drop node bus terminal is electrically connected to two different drop node harness connector terminals and each end node bus terminal is electrically connected to a single end node harness connector terminal.

17. The harness assembly of claim 14, wherein each drop node bus terminal is configured to be electrically connected to two different device terminals through the corresponding drop node harness connector terminals mated with the two different device terminals and each end node bus terminal is configured to be electrically connected to two different device terminals, one through the corresponding end node harness connector terminal mated with the device terminal and the other through a direct connection with the other device terminal.

18. The harness assembly of claim 14, wherein the drop node mating beams include a first mating beam having a first mating interface electrically coupled to the corresponding drop node harness connector terminal and a second mating beam having a second mating interface electrically coupled to a different corresponding drop node harness connector terminal.

19. The harness assembly of claim 14, wherein the end node mating beams include a first mating beam having a first mating interface electrically coupled to the corresponding end node harness connector terminal that is mated with a first device terminal of the device terminals and a second mating beam having a second mating interface configured to be directly coupled to a second device terminal of the device terminals.

20. An electrical connector system for a vehicle, the electrical connector system comprising:
electrical devices electrically connected to a device controller, each electrical device including a circuit board, a device housing mounted to the circuit board, and device terminals held by the device housing and coupled to the circuit board; and
a harness assembly electrically connected to the electrical devices, the harness assembly including a cable assembly including a plurality of wires and harness connectors coupled to the corresponding wires of the cable assembly and configured to be mated with the corresponding electrical devices, the harness assembly including bussing components for electrical bussing of the electrical devices;
each harness connector including a harness connector housing and harness connector terminals terminated to the corresponding wires of the cable assembly, the harness connector housing including a mating end configured to be mated with the corresponding device connector and a cable end with the wires extending from the cable end, the harness connector housing including terminal channels holding the corresponding harness connector terminals, each harness connector terminal including a mating end and a terminating end, the terminating end terminated to an end of the corresponding wire, the mating end configured to be mated with the corresponding device terminal of the device connector to create a signal path between the wire and the corresponding device terminal; and
each harness connector holding bus terminals in the harness connector housing, the bus terminals including mating beams electrically connected to the corresponding harness connector terminals for electrical bussing of the electrical devices.
